(19) United States
(12) Patent Application Publication
(10) Pub. No.: US 2015/0285649 A1
(43) Pub. Date: Oct. 8, 2015

(54) METHOD AND APPARATUS FOR DETERMINING TRAFFIC ROUTE IN ELECTRONIC MAP

(71) Applicant: Tencent Technology (Shenzhen) Co., Ltd., Shenzhen (CN)

(72) Inventors: Xianxin ZHANG, Shenzhen (CN); Kang ZHOU, Shenzhen (CN); Haibo LU, Shenzhen (CN); Jianyu WANG, Shenzhen (CN)

(21) Appl. No.: 14/742,315

(22) Filed: Jun. 17, 2015

Related U.S. Application Data
(63) Continuation of application No. PCT/CN2013/088278, filed on Dec. 2, 2013.

(30) Foreign Application Priority Data
Dec. 25, 2012 (CN) 201210570511.8

(51) Int. Cl. G01C 21/34; G01C 21/36

(52) U.S. Cl. CPC G01C 21/3423; G01C 21/3667

(57) ABSTRACT

A method and an apparatus for determining a traffic route in an electronic map are provided. The method includes: determining by a server that includes a processor, a route start point and a route end point entered through a terminal device that includes a processor; calculating a sectional riding route between the route start point and the route end point in an electronic map road network, setting identification information in the sectional riding route; calculating a sectional walking route corresponding to the sectional riding route in the electronic map road network, integrating the sectional walking route and the sectional riding route into a traffic route according to the identification information, and displaying the traffic route on the terminal device.

### CROSS-REFERENCES TO RELATED APPLICATIONS

This application is a continuation of PCT/CN2013/088278, filed on Dec. 2, 2013, which claims priority to Chinese Patent Application No. 201210570511.8, filed on Dec. 25, 2012 to the State Intellectual Property Office of the People's Republic of China, and titled “METHOD AND APPARATUS FOR DETERMINING TRAFFIC ROUTE IN ELECTRONIC MAP”, which are incorporated herein by reference to their entireties.

### TECHNICAL FIELD

Embodiments of the present disclosure relate to the field of electronic map technologies, and more particularly, to a method and an apparatus for determining a traffic route in an electronic map.

### BACKGROUND

Electronic map is stored and viewed digitally by utilizing computer technologies. Currently, in various traffic route search services (for example, a bus or metro route search service) based on electronic maps, after a start point and an end point are input, a bus or metro route result may be obtained. The result is generally described as “Take Bus No. XXX, and reach XXX after XX stations; walk XX meters towards X, and then reach the end point”. A map route is presented as a direct connecting line from the start point to a pick-up point of a bus or metro station and a direct connecting line from a drop-off point of a bus or metro station to the end point.

However, under many circumstances in real life, upon making a search for a bus or metro route, a user expects more indication information related to walking, such as indicating information for indicting how the user is to walk to a bus or metro station, how the user is to walk to a destination after the user gets off a bus or metro train, whether the user is to turn left or turn right, and how far the user is to walk, and the like. Otherwise, the user may easily get lost, and even fail to find a corresponding bus or metro station. In such a case, with the existing technology employing a point-to-point path planning algorithm, reasonable results cannot always be obtained, which does not satisfies user demands.

Therefore, in existing technical solutions, walking indication information cannot be presented to a user, thereby reducing a matching rate of a traffic route in an electronic map.

### SUMMARY

According to an embodiment of the present disclosure, it is provided a method for determining a traffic route in an electronic map, by which not only a riding route can be presented to a user, but also walking route information can be presented to the user, thereby improving a matching rate of a traffic route in an electronic map.

According to an embodiment of the present disclosure, it is also provided an apparatus for determining a traffic route in an electronic map, by which not only a riding route can be presented to a user, but also walking route information can be presented to the user, thereby improving a matching rate of a traffic route in an electronic map.

Specific solutions of the embodiments of the present disclosure are as follows.

A method for determining a traffic route in an electronic map is provided, the method including:
determining a route start point and a route end point;
calculating a sectional riding route between the route start point and the route end point in an electronic map road network, and setting identification information in the sectional riding route; and
calculating a sectional walking route corresponding to the sectional riding route in the electronic map road network, integrating the sectional walking route and the sectional riding route into a traffic route according to the identification information of the sectional riding route, and displaying the traffic route.

An apparatus for determining a traffic route in an electronic map is provided, the apparatus including one or more processors and a memory, where the memory has multiple processor-executable instruction units stored therein, and the multiple instruction units include:
a point determining unit, a sectional riding route determining unit, and a sectional walking route determining unit, where:
the point determining unit is configured to determine a route start point and a route end point;
the sectional riding route determining unit is configured to calculate a sectional riding route between the route start point and the route end point in an electronic map road network, and set identification information in the sectional riding route; and
the sectional walking route determining unit is configured to calculate a sectional walking route corresponding to the sectional riding route in the electronic map road network, integrate the sectional walking route and the sectional riding route into a traffic route according to the identification information of the sectional riding route, and display the traffic route.

A non-volatile computer-readable storage medium is provided, the storage medium including a computer instruction, where the computer instruction is executable by one or more processors to execute the following operations:
determining a route start point and a route end point;
calculating a sectional riding route between the route start point and the route end point in an electronic map road network, and setting identification information in the sectional riding route; and
calculating a sectional walking route corresponding to the sectional riding route in the electronic map road network, integrating the sectional walking route and the sectional riding route into a traffic route according to the identification information of the sectional riding route, and displaying the traffic route.

From the above technical solutions, it can be found that in the embodiments of the present disclosure, a route start point and a route end point are determined; a sectional riding route between the route start point and the route end point is calculated in an electronic map road network, and identification information is set in the sectional riding route; and a sectional walking route corresponding to the sectional riding route is calculated in the electronic map road network, the sectional walking route and the sectional riding route are integrated into a traffic route according to the identification information of the sectional riding route, and the traffic route is displayed. It can be seen that, with the embodiments of the present disclosure, a walking route result can be integrated into a bus or metro riding route result for presentation. According to the embodiments of the present disclosure, a user is provided with detailed and abundant walking route indication information, thereby improving a matching rate of a traffic route in an electronic map.

### BRIEF DESCRIPTION OF THE DRAWINGS

FIG. 1 is a schematic diagram of an apparatus for determining a traffic route in an electronic map according to an embodiment of the present disclosure;

FIG. 2 is a flowchart of a method for determining a traffic route in an electronic map according to an embodiment of the present disclosure;

FIG. 3 is a schematic diagram of displaying a traffic route in an electronic map according to an embodiment of the present disclosure;

FIG. 4 is a schematic diagram of displaying a traffic route in an electronic map according to another embodiment of the present disclosure; and

FIG. 5 is a structural diagram of an apparatus for determining a traffic route in an electronic map according to an embodiment of the present disclosure.

### DETAILED DESCRIPTION

To make the objectives, technical solutions, and advantages of the present disclosure clearer, the following describes the present disclosure in further detail with reference to the accompanying drawings.

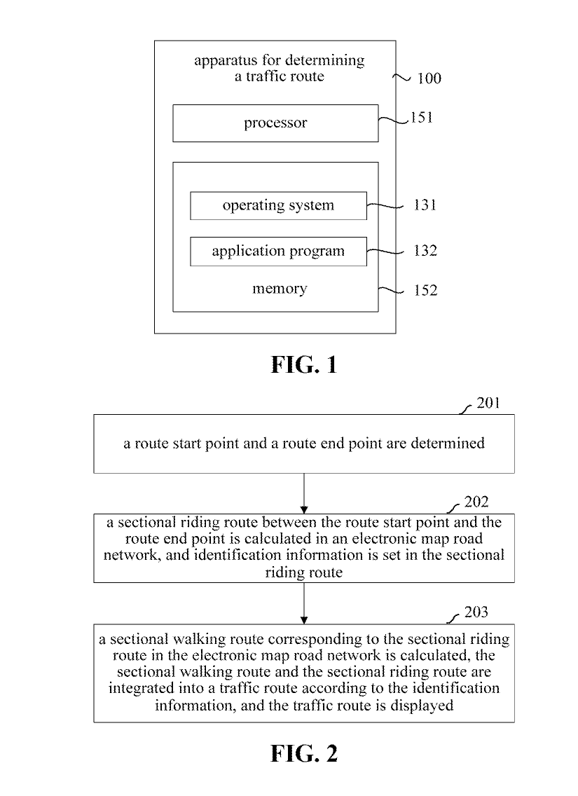

FIG. 1 is a schematic diagram of an apparatus for determining a traffic route in an electronic map according to an embodiment of the present disclosure. An apparatus 100 may implement a method provided by the embodiments of the present disclosure. As shown in FIG. 1, the apparatus 100 includes one or more processors 151 and a non-volatile computer-readable memory 152. The memory 152 has an operating system 131 and an application program 132 stored therein, for example, an application for determining a traffic route in an electronic map that is used to implement a method provided by an embodiment of the present disclosure.

The apparatus 100 may be a server that provides an electronic map service. In such a case, a user provides, by using a terminal device, the server with start point information and end point information of a route that needs to be searched for. The server performs calculation according to the start point information and the end point information, to obtain route information and then return the route information to the terminal device of the user for displaying. In one embodiment, a user may submit, to a background server, start point and end point for searching for a bus/metro route. The background server obtains information about the bus or metro route from the start point to the end point through calculation, and then performs, according to the obtained information about the bus or metro route, calculation for detailed walking information about walking to a bus or metro station, walking to a transfer station, and walking to a destination after the user gets off a bus or metro train. Finally, the background server integrates the information about the bus or metro route and the detailed walking information, and returns the integrated information to the terminal device. The terminal device then presents the integrated information to the user.

The apparatus 100 may also be user equipment. In such a case, the application program 132 in the memory 152 performs calculation according to start point and end point information input by a user, and displays, to the user, route information obtained through calculation.

In this embodiment of the present disclosure, a walking route result is integrated into a bus/metro riding route result for presentation, so as to provide a user with how the user is to walk to a start point such as a bus or metro station of the riding route, how the user is to walk to a stopover point such as a transfer station of the riding route, and how the user is to walk to a destination after the user gets off at a bus or metro station, so that a user is provided with detailed and abundant walking route indication information, thereby improving a matching rate of a traffic route in an electronic map.

FIG. 2 is a flowchart of a method for determining a traffic route in an electronic map according to an embodiment of the present disclosure.

As shown in FIG. 2, the method includes steps 201 to 203.

In step 201, a route start point and a route end point are determined.

A satellite positioning system, for example, Global Positioning System (GPS) from the United States, Beidou Positioning System from China, GLONASS Positioning System from Russia, Galileo Positioning System from Europe, or wireless communication network positioning, Bluetooth positioning and other manners may be used to achieve informatization of physical coordinate data of a real road network. In this step, a route start point and a route end point are first set in an electronic map.

In this embodiment of the present disclosure, a route start point and a route end point may be selected in a manner of direct clicking on an electronic map, and may also be set by inputting a name of a geographic location, and so forth.

An electronic map road network includes geographical coordinate data information of a real road network, called electronic map road network data. The electronic map road network describes coordinate series of each road section and a connection relationship between different road sections. After a route start point and a route end point are set, the route start point and the route end point are respectively introduced into the electronic map road network, that is, correspondences between are between the route start point and the route end point and specific geographical coordinate data in the electronic map road network are respectively established. The specific introduction process may include: determining coordinate data of display positions of the route start point and the route end point in the electronic map; and respectively determining, based on the coordinate data of the display positions of the route start point and the route end point in the electronic map, geographical coordinate data of the route start point and the route end point in the electronic map road network.

In this embodiment of the present disclosure, after the route start point and the route end point are introduced into the electronic map road network, the geographical coordinate data of the route start point and the route end point can be applied to calculate a sectional riding route between the route start point and the route end point as well as distance values.

In step 202, a sectional riding route between the route start point and the route end point in an electronic map road network is calculated, and identification information is set in the sectional riding route.

In this step, a sectional riding route between the route start point and the route end point as well as distance values of sections of the sectional riding route may be calculated with a distance measurement algorithm based on coordinates of the route start point and the route end point. There may be multiple sectional riding routes, which means routes by taking a public transportation other than walking. The existing common public transportation means includes: taxi, bus, subway, light rail, motorcycle, civil aircraft, and the like.

In this step, a pick-up point of interest (POI) and a drop-off point of interest between the route start point and the route end point in the electronic map road network may be calculated by using a shortest path algorithm; and then the sectional riding route between the route start point and the route end point is determined according to the calculated pick-up point of interest and drop-off point of interest.

After determining the sectional riding route (including bus or metro route information), the information of the sectional riding route may be stored in a preset data structure, for example, stored by using a linked list. The storage structure may include a POI at the route start point, a POI at a pick-up station of the first section of the riding route, and a POI at a drop-off station of the first section of the riding route, and so forth until a POI at a pick-up station of the Nth section of the riding route and a POI at a drop-off station of the Nth section of the riding route as well as a POI at the route end point.

There are many algorithms for calculating a riding route and a distance between two points in an electronic map. Generally, a shortest path algorithm is used to calculate a route. Currently, the most commonly-used shortest path algorithms include a Dijkstra's algorithm, an A* algorithm, an SPFA algorithm, a Bellman-Ford algorithm, and a Floyd-Warshall algorithm, and the like.

For example, in this embodiment of the present disclosure, the Dijkstra's algorithm may be used for calculation. The Dijkstra's algorithm is a typical shortest path algorithm, which is used to calculate the shortest path from a point to another point, with a main characteristic of extending toward an outer layer with a start point as a center until extending to an end point. The Dijkstra's algorithm may be used to obtain an optimal solution of the shortest path.

Although some path algorithms are specifically listed as above, a person skilled in the art may recognize that, the path algorithms listed are merely for exemplary purposes, but are not intended to limit the protection scope of the embodiments of the present disclosure.

In some cases, a user may stop over on the way of walking, and preferably in step 201, a stopover point is further set, and the stopover point is introduced into an electronic map road network, that is, a correspondence between the stopover point and a coordinate in the electronic map road network is established. In this case, step 202 may include: calculating a riding route from the route start point to the stopover point in the electronic map road network, and calculating a riding route between the stopover point and the route end point.

If a user changes a stopover point, the stopover point may be updated on the electronic map in a manner of dragging, and then the updated stopover point is introduced into the electronic map road network.

In this case, step 202 may include: presenting on the electronic map a riding route from the route start point to the updated stopover point and then to the route end point as well as a distance value.

In an embodiment, there may be multiple stopover points. In this case, a riding route and a distance value may be calculated according to a sequence of the stopover points that are preset by a user. Specifically, the above shortest path algorithm may also be used to calculate the riding route between the stopover points and distance value.

Similar to the manner of changing a stopover point, the route start point or the route end point may also be changed directly in a manner of dragging on the electronic map. Specifically, after the route start point or the route end point is changed on the electronic map, the updated route start point or the updated route end point is introduced into the electronic map road network, and an updated riding route and distance value continue to be calculated by using the distance measurement algorithm.

In an embodiment of the present disclosure, identification information is set in each sectional riding route, where the identification information is used for identifying each sectional riding route. For example, the first sectional riding route from the route start point is identified as 1, the second sectional riding route from the route start point is identified as 2, and in turn, the N-th sectional riding route from the route start point is identified as N, and so forth. Through identifying each sectional riding route, sectional walking routes between various sectional riding routes may be easily identified, so that the sectional riding routes and the sectional walking routes may be integrated into an integrated traffic route according to a correct sequence.

In step 203, a sectional walking route corresponding to the sectional riding route in the electronic map road network is calculated, the sectional walking route and the sectional riding route are integrated into a traffic route according to the identification information, display the traffic route is displayed.

After the sectional riding route is calculated, a sectional walking route (including a route from the route start point to the first pick-up point of the riding route, and a route from the last drop-off point of the riding route to the route end point) corresponding to the sectional riding route is further calculated.

In this step, a walking start point of interest and a walking end point of interest may be determined according to the route start point, route end point, and sectional riding route; and a shortest path algorithm may be used to determine the sectional walking route corresponding to the sectional riding route according to the walking start point of interest and the walking end point of interest. For example, walking information of a POI from the route start point to a pick-up station of the first section of the riding route may be first calculated; then walking information of a POI from a drop-off station of the first section of the riding route to a pick-up station of the second section of the riding route may be calculated; and so forth, until walking information of a POI from a drop-off station of the N-th section of the riding route to the route end point is calculated.

For calculation of the sectional walking route, a start point and an end point of each sectional walking route, an adjacency matrix of a turning point and a process of storing of searching traffic routes are initialized. It is then determined whether the start point and the end point are valid, that is, whether the start point and the end point are already present in a database of existing route points. If valid, the start point is set to be the first point, and an adjacency matrix of the first point is used to search for all turning points, which are linked in sequence; then, all turning points of points in the link are searched for in turn, and characteristics of the turning points are determined; finally, all the points in the link are searched for and traversed in a reverse order of parent points until the end point, so as to output a walking path from the start point to the end point.

In an embodiment, a sectional walking route corresponding to a sectional riding route is determined according to the identification information of the sectional riding route; and the sectional riding route is integrated with the corresponding sectional walking route, to form a traffic route.

For example, if the first sectional riding route from the route start point is identified as 1, a sectional walking route corresponding to the route identification is from the route start point to a pick-up point of the first sectional riding route; if the second sectional riding route from the route start point is identified as 2, a sectional walking route corresponding to the route identification is from a drop-off point of the first sectional riding route to a pick-up point of the second sectional riding route; and so forth.

A process of integrating the sectional riding route and the sectional walking route may include: firstly reading sectional data from the sectional riding route through traversal, then determining, through traversal, whether each of the sectional data is information of a route from the start point to a pick-up station of the first section, a route from a drop-off station of the first section to a pick-up station of the N-th section, or a route from a drop-off station of the Nth section to the end point. And if yes, searching for, according to the identification information of each section, walking route information corresponding to each of the sectional data from sectional walking route data; then placing the walking route information behind data of the corresponding section in sectional riding route information, and forming a new data structure by using location identification of the corresponding section; and returning the new data including the sectional riding route and sectional walking route to the terminal, so that the terminal displays, according to the data structure, the sectional walking route briefly or in detail based on displaying of the sectional riding route information. When there is less display space of a page, a brief display manner may be used, that is, only brief information is displayed on the page; and when a user needs to view a detailed content, the user unfold the brief information through an operation, to view all detailed content. After viewing, the user may further fold the displayed detailed content, so as to save the display space. For example, a user may unfold or fold a foldable portion through a mouse click operation.

In an embodiment, displaying the traffic route includes: displaying the sectional walking route in the traffic route briefly, or displaying the sectional walking route in the traffic route in detail; or displaying the sectional riding route in the traffic route briefly, or displaying the sectional riding route in the traffic route in detail.

After calculating a traffic route between the route start point and the route end point as well as a distance value of the traffic route, the traffic route and the distance value of the traffic route may be shown in an electronic map in many manners. For example, a highlighting manner may be used to display the traffic route, or the distance value of the traffic route is displayed in a prompt dialog box.

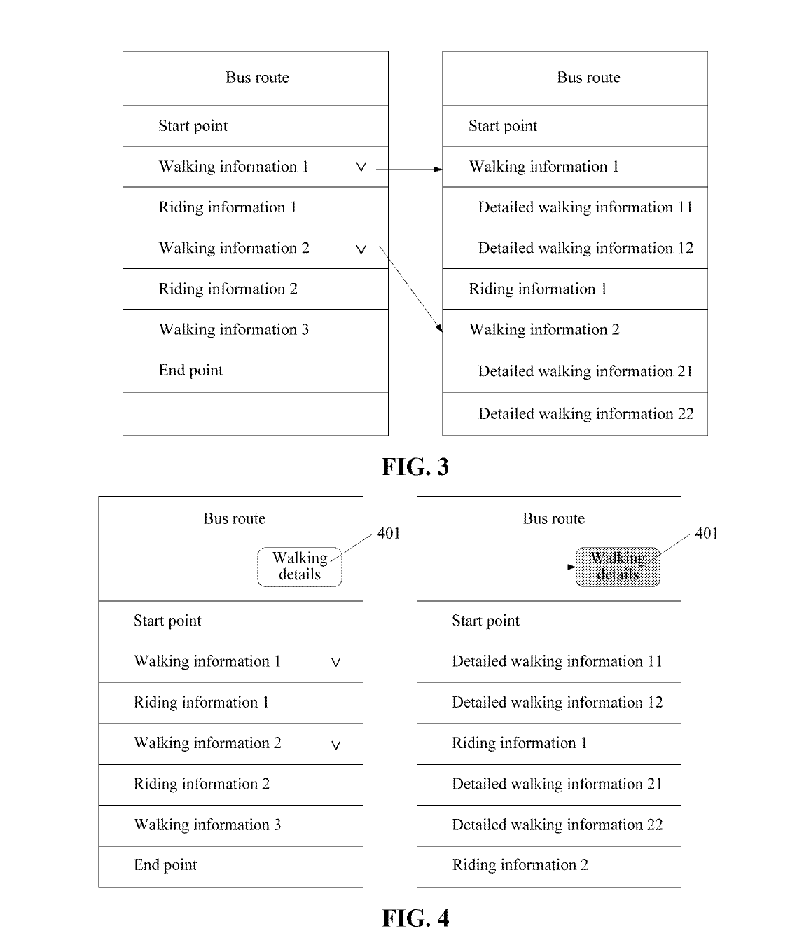

FIG. 3 is a schematic diagram of displaying a traffic route in an electronic map according to an embodiment of the present disclosure.

From FIG. 3, it can be seen that in this embodiment of the present disclosure, detailed information of three sectional walking routes are added to the electronic map, the three sectional walking routes include the walking routes of walking to a bus or metro station, walking to a transfer station, and walking to a destination after getting off from a bus or metro train (as shown in walking information 1, 2, and 3 in FIG. 3).

In FIG. 3, the walking information 1 and 2 includes more detailed information, and a brief display manner is used to reduce occupied page space, which is represented by a drop-down arrow “V” on the right. After a user clicks the drop-down arrow, more details may be unfolded and displayed. As shown in FIG. 3, detailed walking information 11 and 12 is detailed information of the walking information 1, and detailed walking information 21 and 22 is detailed information of the walking information 2. The walking information 3 does not include details, and therefore there is no drop-down arrow on the right. The user can directly access the map by clicking the walking information 3.

FIG. 4 is a schematic diagram of displaying a traffic route in an electronic map according to another embodiment of the present disclosure. In FIG. 4, a button 401 used to unfold or fold walking details is added. A user can unfold or fold all the walking details through clicking the button 401.

According to an embodiment of the present disclosure, it is further provided an apparatus for determining a traffic route in an electronic map.

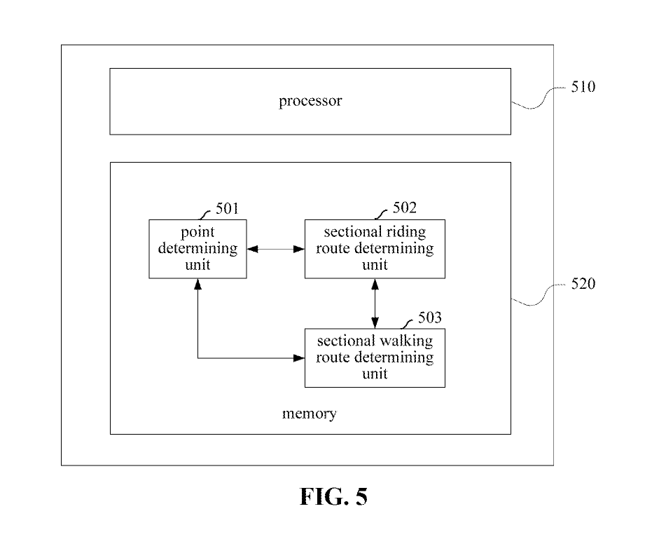

FIG. 5 is a structural diagram of an apparatus for determining a traffic route in an electronic map according to an embodiment of the present disclosure.

As shown in FIG. 5, the apparatus includes: one or more processors 510, and a memory 520, where the memory 520 has multiple instruction units stored therein that are executable by the processor 510, and the multiple instruction units include:
a point determining unit 501, a sectional riding route determining unit 502, and a sectional walking route determining unit 503; where:
the point determining unit 501 is configured to determine a route start point and a route end point;
the sectional riding route determining unit 502 is configured to calculate a sectional riding route between the route start point and the route end point in an electronic map road network, and set identification information in the sectional riding route; and
the sectional walking route determining unit 503 is configured to calculate a sectional walking route from the sectional riding route in the electronic map road network, integrate the sectional walking route and the sectional riding route into a traffic route according to the identification information, and display the traffic route.

In an embodiment, the sectional walking route determining unit 503 is configured to display the sectional walking route in the traffic route briefly, or display the sectional walking route in the traffic route in detail; or display the sectional riding route in the traffic route briefly, or display the sectional riding route in the traffic route in detail.

The sectional riding route determining unit 502 may calculate a pick-up point of interest and a drop-off point of interest between the route start point and the route end point by using a shortest path algorithm; and determine the sectional riding route between the route start point and the route end point according to the calculated pick-up point of interest and drop-off point of interest.

In an embodiment, the sectional walking route determining unit 503 is configured to determine a walking start point of interest and a walking end point of interest according to the route start point, route end point, and sectional riding route; and determine, according to the walking start point of interest and the walking end point of interest, the sectional walking route between the sectional riding routes by using a shortest path algorithm.

In an embodiment, the sectional walking route determining unit 503 is configured to determine, according to identification information of each sectional riding route, a sectional walking route corresponding to each sectional riding route; and integrate each sectional riding route and the corresponding sectional walking route, to form the traffic route.

In fact, an apparatus for determining a traffic route in an electronic map provided in this embodiment of the present disclosure may be specifically implemented in many forms. For example, a plug-in program installed in an electronic map may be written by using an application programming interface that conforms to a particular specification, or an application program may be encapsulated for download and use by a user. When a plug-in program is written, the plug-in program may be implemented in many plug-in forms such as ocx, dll, and cab. The apparatus for determining a traffic route in an electronic map provided in this embodiment of the present disclosure may also be implemented by a Flash plug-in, a RealPlayer plug-in, an MMS plug-in, a MIDI plug-in, an ActiveX plug-in and other specific technologies.

The memory 520 may include, but is not limited to, a floppy disk, an optical disc, a DVD, a hard disk, a flash memory, a USB flash disk, a CF card, an SD card, an MMC card, an SM card, a memory stick, an xD card, and the like.

In conclusion, in the embodiments of the present disclosure, a route start point and a route end point are determined; a sectional riding route between the route start point and the route end point is calculated in an electronic map road network, and identification information is set in the sectional riding route; and a sectional walking route from the sectional riding route is calculated in the electronic map road network, the sectional walking route and the sectional riding route are integrated into a traffic route according to the identification information, and the traffic route is displayed. It can be seen that, with the embodiments of the present disclosure, a walking route result can be integrated into a bus or metro riding route result for presentation. According to the embodiments of the present disclosure, a user is provided with detailed and abundant walking route indication information, thereby improving a matching rate of a traffic route in an electronic map.

Additionally, the embodiments of the present disclosure may be applied in various terminals, and may also be used across platforms and terminals. The application scope is very wide.

It may be understood that the embodiments of the disclosure for determining a traffic route in an electronic map may be embodied as computer instruction stored in a computer readable medium, when executed by one or more processors on a server, may cause the server to execute the steps in the described method or performing the functions by the server. The computer instructions may be stored in a memory (e.g., a computer-readable storage medium, such as a hard disk, an optical disk, a solid state memory such as a flash memory) on a server, or in a cloud memory accessed via an Internet connection. The computer instructions may be hardware program codes modules constituted as logic gates microcodes within a ROM, a processor or a controller, or as functional modules constituted by both software/hardware together.

The above descriptions merely show preferred embodiments of the present disclosure, but are not intended to limit the present disclosure. Any modification, equivalent replacement, and improvement made within the spirit and principle of the present disclosure shall fall within the protection scope of the present disclosure.

What is claimed is:

1. A method for determining a traffic route in an electronic map, comprising:
determining by a server that includes a processor, a route start point and a route end point entered through a terminal device that includes a processor, wherein the terminal communicates to the server through a network connection;
calculating by the server, a sectional riding route between the route start point and the route end point in an electronic map road network, and setting identification information in the sectional riding route; and
calculating by the server, a sectional walking route corresponding to the sectional riding route in the electronic map road network, integrating the sectional walking route and the sectional riding route into a traffic route according to the identification information of the sectional riding route, and
displaying the traffic route on the terminal device.

2. The method for determining a traffic route in an electronic map according to claim 1, wherein the displaying of the traffic route on the terminal device, comprises:
displaying the sectional walking route in the traffic route briefly, or displaying the sectional walking route in the traffic route in detail; or
displaying the sectional riding route in the traffic route briefly, or displaying the sectional riding route in the traffic route in detail.

3. The method for determining a traffic route in an electronic map according to claim 1, wherein the calculating of the sectional riding route between the route start point and the route end point, comprises the server:
calculating a pick-up point of interest and a drop-off point of interest between the route start point and the route end point in the electronic map road network by using a shortest path algorithm; and
determining the sectional riding route between the route start point and the route end point according to the calculated pick-up point of interest and drop-off point of interest.

4. The method for determining a traffic route in an electronic map according to claim 1, wherein the calculating of the sectional walking route corresponding to the sectional riding route in the electronic map road network, comprises the server:
determining a walking start point of interest and a walking end point of interest according to the route start point, the route end point, and the sectional riding route; and
determining, according to the walking start point of interest and the walking end point of interest, the sectional walking route corresponding to the sectional riding route by using a shortest path algorithm.

5. The method for determining a traffic route in an electronic map according to claim 1, wherein the integrating of the sectional walking route and the sectional riding route into a traffic route according to the identification information of the sectional riding route, comprises the server:
determining, according to the identification information of the sectional riding route, the sectional walking route corresponding to the sectional riding route; and
integrating the sectional riding route and the sectional walking route, to form the traffic route.

6. An apparatus for determining a traffic route in an electronic map, wherein the apparatus comprises one or more processors and a memory having processor-executable instructions stored therein, and the instructions when executed by one or more processors, configures the apparatus to:
determine a route start point and a route end point entered through a terminal device that includes a processor, wherein the terminal communicates to the apparatus through a network connection;
calculate a sectional riding route between the route start point and the route end point in an electronic map road network, and set identification information in the sectional riding route; and
calculate a sectional walking route corresponding to the sectional riding route in the electronic map road network, integrate the sectional walking route and the sectional riding route into a traffic route according to the identification information of the sectional riding route, and display the traffic route on the terminal device.

7. The apparatus for determining a traffic route in an electronic map according to claim 6, wherein the apparatus is further configured to display one or more of the following on the terminal device:
display the sectional walking route in the traffic route briefly,
display the sectional walking route in the traffic route in detail;
display the sectional riding route in the traffic route briefly, and
display the sectional riding route in the traffic route in detail.

8. The apparatus for determining a traffic route in an electronic map according to claim 6, wherein the apparatus is further configured to:
calculate a pick-up point of interest and a drop-off point of interest between the route start point and the route end point in the electronic map road network by using a shortest path algorithm; and
determine the sectional riding route between the route start point and the route end point according to the calculated pick-up point of interest and drop-off point of interest.

9. The apparatus for determining a traffic route in an electronic map according to claim 6, wherein the apparatus is further configured to:
determine a walking start point of interest and a walking end point of interest according to the route start point, the route end point, and the sectional riding route; and
determine, according to the walking start point of interest and the walking end point of interest, the sectional walking route corresponding to the sectional riding route by using a shortest path algorithm.

10. The apparatus for determining a traffic route in an electronic map according to claim 6, wherein the apparatus is further configured to:
determine, according to the identification information of the sectional riding route, the sectional walking route corresponding to the sectional riding route; and
integrate the sectional riding route and the corresponding sectional walking route, to form the traffic route.

11. A non-volatile computer-readable storage medium, comprising computer instructions stored there-on, wherein the computer instruction being executable by one or more processors on a server to cause the server to execute the following operations:
determining a route start point and a route end point entered through a terminal device that includes a processor, wherein the terminal communicates to the server through a network connection;
calculating a sectional riding route between the route start point and the route end point in an electronic map road network, and setting identification information in the sectional riding route; and
calculating a sectional walking route corresponding to the sectional riding route in the electronic map road network, integrating the sectional walking route and the sectional riding route into a traffic route according to the identification information of the sectional riding route, and displaying the traffic route on the terminal device.

12. The storage medium according to claim 11, wherein the displaying of the traffic route on the terminal device, comprises:
displaying the sectional walking route in the traffic route briefly, or displaying the sectional walking route in the traffic route in detail; or
displaying the sectional riding route in the traffic route briefly, or displaying the sectional riding route in the traffic route in detail.

13. The storage medium according to claim 11, wherein the calculating of the sectional riding route between the route start point and the route end point, comprises causing the server:
calculating a pick-up point of interest and a drop-off point of interest between the route start point and the route end point in the electronic map road network by using a shortest path algorithm; and
determining a sectional riding route between the route start point and the route end point according to the calculated pick-up point of interest and drop-off point of interest.

14. The storage medium according to claim 11, wherein the calculating of the sectional walking route from the sectional riding route in the electronic map road network, comprises causing the server:
determining a walking start point of interest and a walking end point of interest according to the route start point, the route end point, and the sectional riding route; and
determining, according to the walking start point of interest and the walking end point of interest, the sectional walking route corresponding to the sectional riding route by using a shortest path algorithm.

15. The storage medium according to claim 11, wherein the integrating of the sectional walking route and the sectional riding route into a traffic route according to the identification information of the sectional riding route, comprises causing the server:
determining, according to the identification information of the sectional riding route, the sectional walking route corresponding to the sectional riding route; and
integrating the sectional riding route and the sectional walking route, to form a traffic route.
